(19) United States
(12) Patent Application Publication
(10) Pub. No.: US 2008/0306956 A1
(43) Pub. Date: Dec. 11, 2008

(54) METHOD AND SYSTEM FOR DEVELOPING USER PROFILE ON A NETWORK

(75) Inventors: Nicholas Werthessen, Millis, MA (US); Eric V. Schultz, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Quantia Communications, Newton, MA (US)

(21) Appl. No.: 12/134,039

(22) Filed: Jun. 5, 2008

Related U.S. Application Data
(60) Provisional application No. 60/933,533, filed on Jun. 7, 2007.

(51) Int. Cl. G06F 17/30; G06F 7/00

(52) U.S. Cl. 707/9; 707/102; 707/E17.005

(57) ABSTRACT

In an on-line networking community, a method and corresponding system develops detailed user profiles using basic information provided by the user. In one example embodiment, a web server accepts user submitted information from a user and correlates the user submitted information with available databases to retrieve supplemental information about the individual user. Using the supplemental information, the system creates and outputs for community viewing a compound user profile.

### RELATED APPLICATION(S)

This application claims the benefit of U.S. Provisional Application No. 60/933,533, filed on Jun. 7, 2007. The entire teachings of the above application(s) are incorporated herein by reference.

### BACKGROUND OF THE INVENTION

The Internet and its related technologies have introduced a number of ways for individuals to make contact and communication with one another, whether personal or professional. One such way has been through community networking websites or social networking services.

A social networking service focuses on the building and verifying of on-line social networks for communities of people who share interests and activities, or who are interested in exploring the interests and activities of others. Most social network services are primarily web based and provide a collection of various ways for users to interact, such as chatting, messaging, emailing, video messaging, voice chatting, file sharing, blogging, participating in discussion groups, and so on.

In general, social networking websites allow users to create profiles for themselves by providing to the site basic information, and in some cases, a registration fee. As part of the on-line community, users can connect with one another. In most social networking services, user profiles may include private and public information. The level of access a user has to other users' private or public information may depend on the established relationship of the parties. For example, if two people have established a “contact,” then the site may provide them access with each others' private profiles. Some web communities have privacy controls that allow users to choose who may view their profile or contact them.

### SUMMARY OF THE INVENTION

In an on-line networking community, a computer method and corresponding system develops detailed user profiles using basic information provided by the user. In one example embodiment, a web server accepts user-submitted information from a user and correlates the user-submitted information with available databases to retrieve matching and/or supplemental information about the individual user. Using the matching and/or supplemental information, the system creates a compound user profile.

This compound user profile allows for a real-time update of community-users' information based on content gathering from global computer networks and privately accessible databases. The ability for a user's information to be constantly maintained and updated by a system, without a user having to access the site, simplifies the profiling systems that are currently available. Because the system searches for new, additional, and updated data regarding the community user on any global computer network or privately accessible database, the user is spared the time and effort of having to frequently return to the same site in order to keep his or her credentials and information recent.

The invention compound user profile benefits the user by allowing him or her to feel confident that his or her profile contains the most up-to-date information without having to manually input that information. Concurrently, this system of a compound user profile benefits others by creating and monitoring an extensive collection of data that is gathered from a variety of media sources and compiled into one location without any further input, besides the initial registration, from a user. The compound user profile provides users with the ability to interact with other community users via one service, which has combined all pertinent user data into one non-invasive, interconnected system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1-6 are schematic illustrations (screen views) of web pages employed for the method and system for developing user profiles according to an example embodiment of the invention.

FIG. 7 is a flow diagram of an embodiment of the present invention.

FIG. 8 is a schematic view of a computer environment in which the principles of the invention may be implemented.

FIG. 9 is a block diagram of the internal structure of a computer from the FIG. 8 computer environment.

### DETAILED DESCRIPTION OF THE INVENTION

A description of preferred embodiments of the invention follows.

In an on-line networking community, a computer method and system creates a rich end-user profile by taking a user's basic information, given during registration for example, and researching within available databases to create a compound profile having the supplemental information. This method could be used in a variety of contexts including community, personalization, and directory applications.

Nearly all on-line community sites (e.g., MySpace, Facebook, and LinkedIn) aspire to rich profiles of their users, yet the vast majority of registrations do not result in a profile having more than the user's name and a few pieces of information collected during registration. It is also the case that users do not create a rich profile on the site until they have developed affinity for the site, yet often do not develop affinity for the site because they have no established identity there. The success of these sites depends on user participation, and the information provided by users of their on-line community.

The computer method and system of the invention provides a rich profile for the user from the very beginning of his or her experience with the site. This service may be provided to on-line community sites to create publicly accessible profiles for its members. In particular example embodiments of the invention directed to professional networks, when a member joins, they provide basic information about themselves, such as First Name, Last Name, Zip Code, and professional credentials. With this limited information, the system in turn researches the existing information available on global computer networks and creates a profile that provides a great deal of detail about the user. The advantage to the user is that very little effort is required of him. The advantage to the on-line community and social network is that very detailed profiles exist for nearly all members of the service from the beginning, as opposed to waiting for the user to make additions.

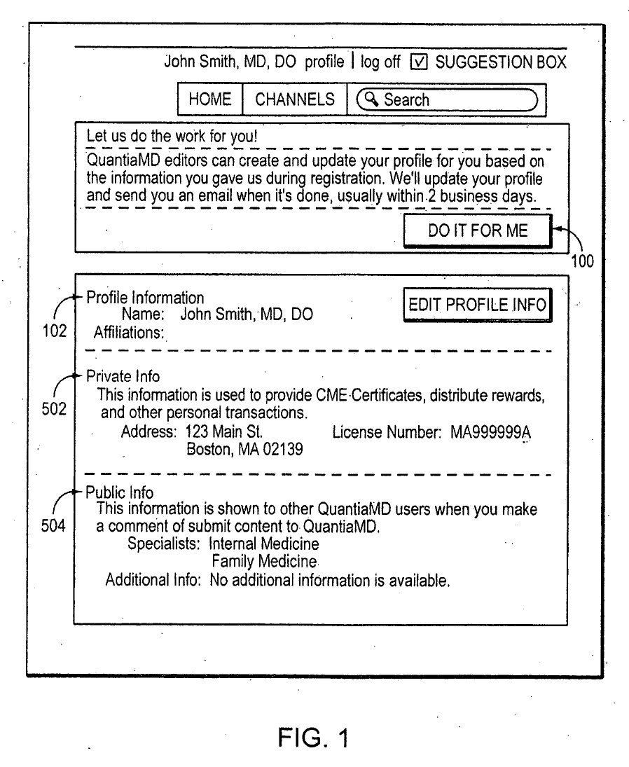

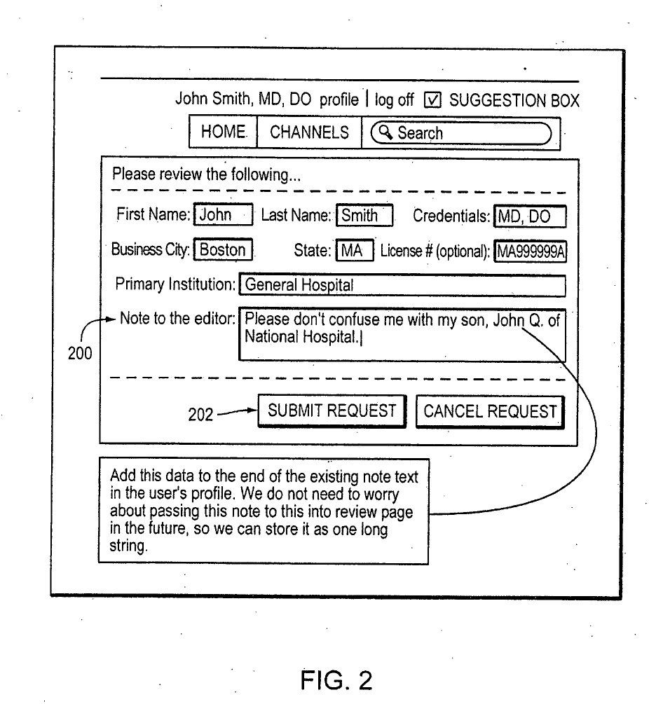

FIGS. 1-6 are webpages illustrating the method and system for developing user profiles according to an example embodiment of the present invention. The figures illustrate a web interface that may be used in connection with the registration and development of user profiles in a global computer network (e.g., Internet) community directed at physicians. In the figures, a user may submit basic information about himself or herself and allow the system to generate a detailed profile using available information, including for example, privately maintained databases or the Internet (or similar global computer networks). FIG. 1 illustrates a basic user profile of a physician in an example on-line network community. The basis user profile 102 has a “private information” 502 portion and a “public information” 504 portion. In the example webpage of FIG. 1, the system provides the user with the option “Do It For Me” 100, which, if requested, allows the system editors to create and update the user's profile based on the information the user previously provided during registration and based on system generated further information. When this update is completed, the system sends an email message to the user indicating such. In the example webpage of FIG. 2, the user has provided information through a user interface. In the example webpage of FIG. 2, the user can communicate directly with the system editors by writing requests, comments, or questions in the “Note to the editor” field 200 provided, and then transmitting the information the user wants a system editor to review by pressing the “Submit Request to the Editor” button 202.

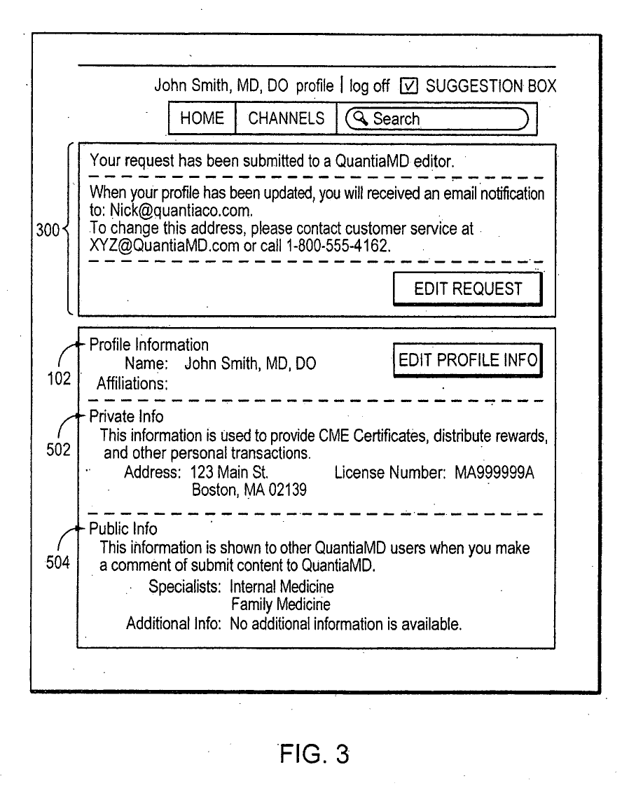

As shown in FIG. 3, after a user authorizes the development of a compound profile (for example, through operation of option 100 in FIG. 1), the system acknowledges (at 300) through the web interface that the compound profile is being processed (prepared or otherwise generated). Using the basic information provided by the user (and initially presented in the basic user profile 102), the system determines key words, performs keyword searches, and correlates that basic information with information found in a variety of sources, such as the Internet (or similar global computer networks) or private databases. The system may provide for manual correlation of the information by having individuals perform database searches, and review and extract relevant information for entry into a more detailed user profile (or compound user profile 10). Alternatively or concurrently, software modules (e.g., crawlers or agents) may be used to search various keywords in an iterative manner, and filter information tagged for predetermined information fields, such as “undergraduate institution,” or “publications.”

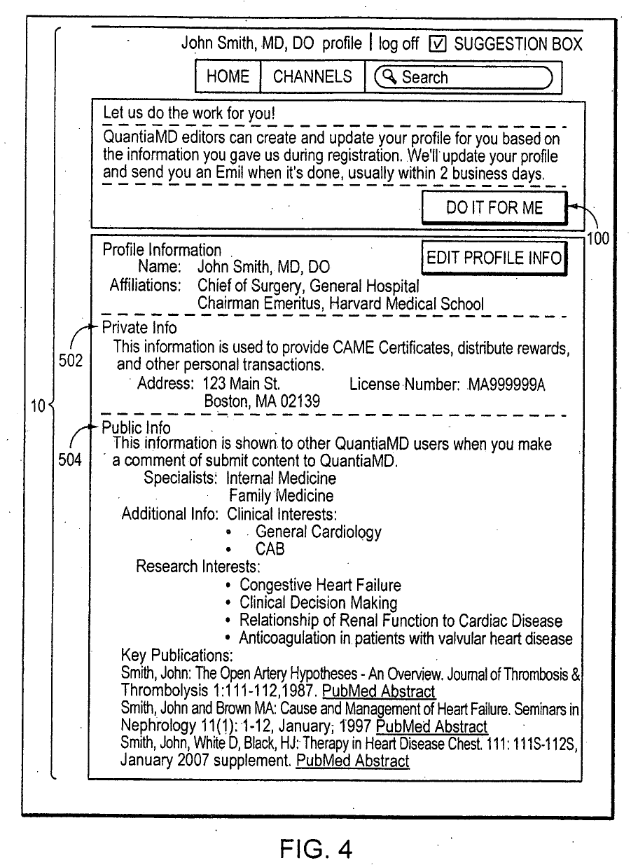

The foregoing results in a draft compound profile 10. FIG. 4 illustrates an example compound profile 10 provided by the system based on the user-provided information and comments in FIG. 2. That is, compound profile 10 is the updated and improved in detail version of the basic user profile 102 of FIG. 3. The compound profile 10 has a “private information” 502 portion on a “public information” 504 portion like basic user profile 102, but the contents of these portions are much more extensive in compound profile 10.

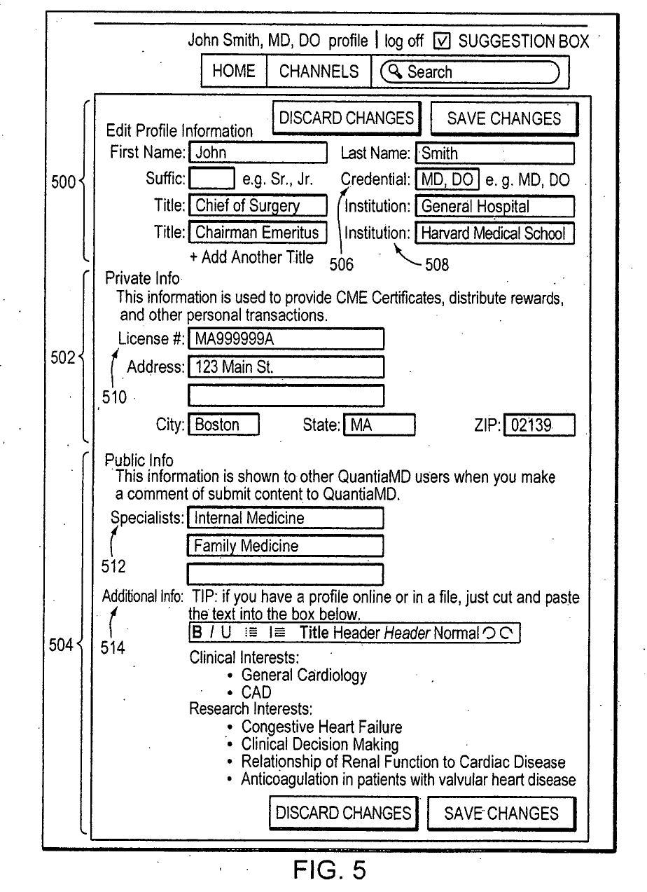

At FIG. 5, the web interface allows the user to edit any information on his or her draft compound profile 10 in order to allow further development or clarification of the information on his or her profile. FIG. 5 has three distinct sections for the user to enter and edit his or her information. The first section allows for general information 500 about the user, such as his or her credentials 506 and institution 508 where he or she works. The second section available in FIG. 5 allows for a user to enter private information 502, such as his or her license number 510. The third section available in FIG. 5 allows a user to enter any information he or she wishes to be public information 504, such as specialties 512 and additional information/interests 514.

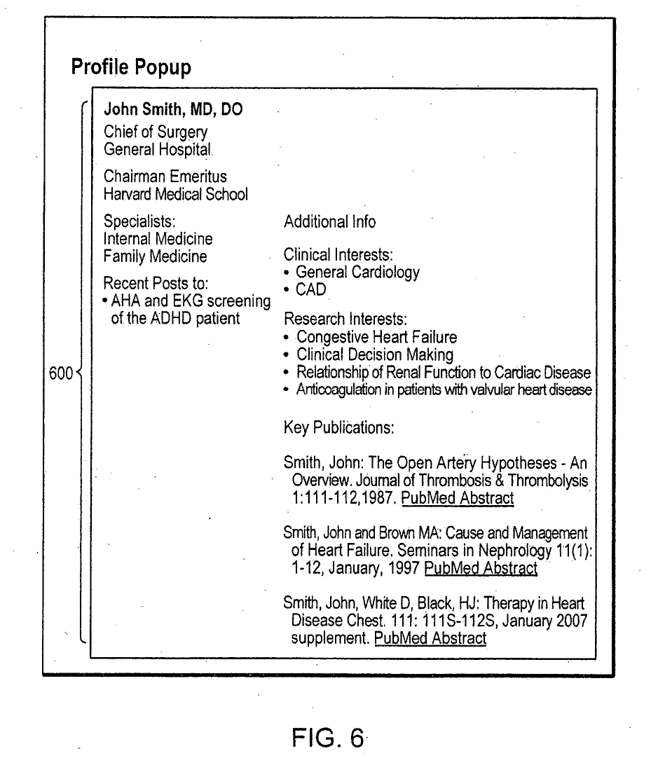

FIG. 6 illustrates a user profile “pop-up” 600 for viewing by a user or subscriber to the on-line network. The pop-up 600 presents name, title and other pertinent information about a user based on his compound profile 10. Note the richness and depth of the content, which is a direct result of the invention compound profile 10 and method for generating the same in a timely (early stage) manner.

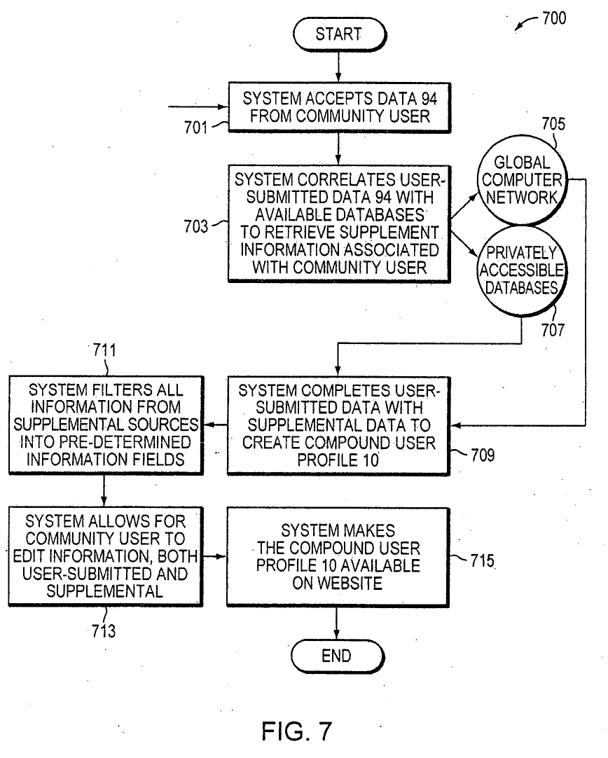

FIG. 7 is a flow diagram of one embodiment of the present invention. Specifically, FIG. 7 diagrams the routine one embodiment 700 of this invention implements in order to receive input 701 from a community user and search for supplemental data from Global Computer Networks 705 and Privately Accessible Databases 707. After prompting for and receiving user-submitted data 701, the system 700 correlates said data with available databases in order to retrieve all supplemental information associated with that specific community user 703. The system 700 then compiles 709 the user-submitted data from 701 with the supplemental data from 705 and 707 to create a compound user profile 10. Once supplemental data is found, the system 700 filters 711 said information into pre-determined information fields in the community-user's compound user profile 10. At all times the system 700 allows the community user to edit 713 his or her compound user profile 10. In some embodiments, the system 700 continuously or at some frequency searches and retrieves supplemental information and updated information from database sources 705, 707, and recompiles the latest gained information and user edits into compound profile 10. At the end of this routine the system makes the compound user profile 10 available 715 on the website for other community users to access beginning as early as registration stage of the user profiled. This addresses and solves the above-noted problems of the prior art.

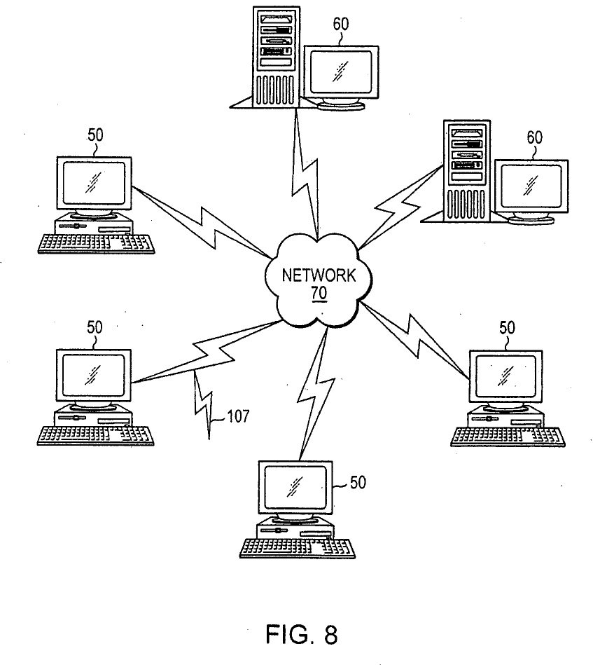

FIG. 8 illustrates a computer network or similar digital processing environment in which the invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, local area or wide area networks, and gateways that currently use respective protocols (TCP/IP, Bluetooth, etc.) to communicate with one another. Other electronic device/computer network architectures are suitable.

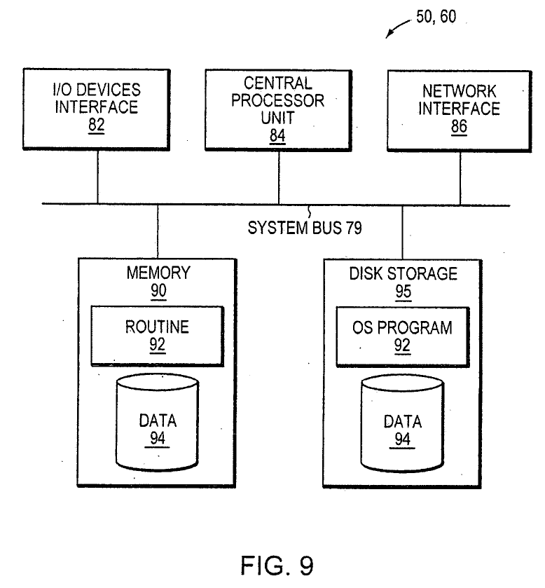

FIG. 9 is a diagram of the internal structure of a computer (e.g., client processor/device 50 or server computers 60) in the computer system of FIG. 8. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 8). Memory 90 provides volatile storage for computer software instructions 92 and data 94 (e.g., routine 700) used to implement an embodiment of the invention (e.g., to further search, to correlate user submitted information with available database information, to retrieve supplemental information corresponding to the user, and to update the user profile in the profile database to create a compound user profile using the supplemental information as described above). Disk storage 95 provides non-volatile storage for computer software instructions 92 and data 94 used to implement an embodiment of the invention (e.g., the profile database). Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROMs, CD-ROMs, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or “transient carrier” encompasses the foregoing transient signals, propagated signals, propagated medium, storage medium and the like.

It should be apparent to those of ordinary skill in the art that methods involved in the invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims. For example, the invention may be implemented in a variety of computer architectures. The computer network of FIGS. 8 and 9 are for purposes of illustration and not limitation of the invention.

Further, mention of “the Internet” is for purposes of illustration, not limitation. Other multiple global computer networks may be suitable in connection with embodiments of the present invention.

What is claimed is:

1. A computer method for developing user profiles on a website, the method comprising:
accepting user submitted information from a user;
correlating user submitted information with available databases to retrieve supplemental information associated with the user;
creating a compound user profile of the supplemental information.

2. A method of claim 1 wherein the available databases include information available on a global computer network.

3. A method of claim 1 wherein the available databases include a privately accessible database.

4. A method of claim 1 wherein creating a compound profile further includes filtering supplemental information into predetermined information fields.

5. A method of claim 1 wherein the user submitted information includes any combination of a First Name, Last Name, Zip Code, and professional credentials.

6. A method of claim 5 wherein professional credentials further include medical institution affiliations, medical specialties, or medical board certifications.

7. A method of claim 1 further comprising:
making the compound user profile available for viewing on the website at a relatively early stage.

8. A method of claim 7 further comprising:
limiting to registered community users the availability for viewing the compound user profile.

9. A system for developing user profiles on a website, the system comprising:
a network interface configured to receive user submitted information from a user;
a profile database communicating with the network interface to store the user submitted information in a user profile;
a processor configured to correlate user submitted information with available databases to retrieve supplemental information corresponding to the user and to update the user profile in the profile database to create a compound user profile using the supplemental information.

10. A system of claim 9 wherein the available databases include information available on a global computer network.

11. A system of claim 9 wherein the available databases includes a privately accessible database.

12. A system of claim 9 wherein creating a compound profile further includes filtering supplemental information into predetermined information fields.

13. A system of claim 9 wherein the user submitted information includes any combination of a First Name, Last Name, Zip Code, and professional credentials.

14. A system of claim 13 wherein professional credentials further include medical institution affiliations, medical specialties, or medical board certifications.

15. A system of claim 9 further comprising:
making the compound user profile available for viewing on the website at a relatively early stage.

16. A system of claim 15 further comprising:
limiting to registered users the availability for viewing the compound user profile.

17. A computer-readable medium having stored thereon sequences of instructions, the sequences of instructions including instruction, when executed by a processor, causes the processor to perform:
accepting user submitted information from a user;
correlating user submitted information with available databases to retrieve supplemental information corresponding to the user; and
creating and outputting to a community of users a compound profile of the supplemental information.
